(19) United States
(12) Patent Application Publication
(10) Pub. No.: US 2025/0178096 A1
(43) Pub. Date: Jun. 5, 2025

(54) MICRO VIBRATION DAMPING SYSTEM FOR TURNING PROCESS AND METHOD THEREOF

(71) Applicant: HANWHA PRECISION MACHINERY CO., LTD., Changwon-si (KR)

(72) Inventor: Cheol Hong BYEON, Changwon-si (KR)

(73) Assignee: HANWHA PRECISION MACHINERY CO., LTD., Changwon-si (KR)

(21) Appl. No.: 19/044,096

(22) Filed: Feb. 3, 2025

Related U.S. Application Data
(63) Continuation of application No. PCT/KR2023/010936, filed on Jul. 27, 2023.

(30) Foreign Application Priority Data
Aug. 2, 2022 (KR) 10-2022-0096055

(51) Int. Cl. B23B 13/08

(52) U.S. Cl. CPC B23B 13/08

(57) ABSTRACT

A micro vibration damping system includes: one or more sensors configured to sense an instantaneous acceleration of a tool post during machining of a work piece; and a driver configured to drive the tool post in a direction orthogonal to an axial direction of the work piece according to the instantaneous acceleration of the tool post.

### CROSS-REFERENCE TO RELATED APPLICATION

This application a bypass continuation application of International Application No. PCT/KR2023/010936 filed on Jul. 27, 2023, in the Korean Intellectual Property Receiving Office, which is based on and claims priority to Korean Patent Application No. 10-2022-0096055, filed on Aug. 2, 2022, in the Korean Intellectual Property Office, the disclosure of which is incorporated by reference herein in its entirety.

### BACKGROUND

### 1. Field

The present disclosure relates to a micro vibration damping system for a turning process capable of controlling micro vibrations generated in a tool post by applying a control algorithm that generates vibrations in an opposite direction to a vibration direction appearing in the tool post during an instantaneous direction change, stop, or acceleration for a turning process, and a method thereof.

### 2. Description of Related Art

An automatic lathe is a machining device that may simultaneously perform left and right side surface machining and front surface machining of a work piece in a state in which the work piece is chucked on a main spindle and guided by a guide bush. A machining cycle time may be reduced when the work piece is machined using an automatic lathe. An automatic lathe may be provided for a “turning” process which is a machine process in which a lathe is used to rotate the work piece while the spindle moves in a linear motion to remove material along a diameter of the work piece.

In addition, the automatic lathe is a lathe machining device suitable for mass production by automatically performing most of the preparing, machining, and finishing processes such as input of a material, production of the product, and discharge of a finished product.

In the case of a machining method of a general automatic lathe, a machining chip is generated during machining of a work piece. When the generated machining chip is excessively long or a discharge direction of the generated machining chip is not a preferred direction, the chip is rolled around the work piece or a scratch is generated on the work piece, which causes a problem in machining a target shape.

Accordingly, chip segmentation of the machining chip generated during the machining of the work piece generates a difference in precision of the machining of the work piece. Accordingly, a problem such as precision generated in the work piece during the machining of the work piece has been solved through the segmentation of the machining chip generated during the machining of the work piece. There are two solutions for such segmentation of the machining chip: (1) a solution through a tool; and (2) a solution through a control algorithm. These solutions may be described in Korean Patent Application Number 20-0490042. However, the following issues with the solutions described in Korean Patent Application Number 20-0490042 are described below.

First, the solution for segmenting the machining chip using the tool may be provided to optimize a chip breaker shape of a cutting tool for each tool maker and control chip segmentation to facilitate chip control.

However, in such a control method for segmenting the chip using the tool, the chip is segmented by repeating a rapid direction change due to forward movement and backward movement of the tool mounted on a tool post along a machining path during machining of the tool. As the rapid direction change, due to the forward movement and the backward movement of the tool, is repeated, vibrations are generated in the tool post, particularly in the work piece that is machined. Due to such vibrations, there is a problem that surface roughness of the work piece deteriorates at an increased rate compared to an existing cutting method. In addition, as the vibrations are continuously generated, stress is continuously applied to an equipment, and a problem that the overall durability of the equipment is reduced due to the stress of the equipment occurs.

In the solution for segmenting the machining chip through the control algorithm, the chip may be segmented or control may be facilitated by programming a path for segmenting the chip at intervals in consideration of a machining path for machining the work piece.

A method of controlling the chip segmentation of the work piece through the control algorithm includes continuously changing a movement speed of the tool for the purpose of the chip segmentation. However, when the movement speed of the tool is continuously changed, the quality of the surface roughness of the work piece decreases.

Accordingly, in the above-described methods for solving the chip segmentation, the chip is segmented through an instantaneous direction change, but there is a problem that the surface roughness of the work piece deteriorates due to the generated vibrations and the like, and a fine band is generated in a product because vibrations are also generated in the tool due to instantaneous stop and acceleration even when the chip is segmented through the change in the movement speed of the tool.

In addition, vibrations may be generated in the automatic lathe itself in addition to the tool post or the tool. When the vibrations are generated in the automatic lathe, instantaneous vibrations are generated in a downward direction in the tool post due to gravity and weight of the tool post. In this case, when the tool post is located above a material, a fine valley is formed in the product, and when the tool post is located below the material, a fine ridge is formed in the product. A fine band shape that appears as described above has a negative effect on the surface roughness of the work piece.

### SUMMARY

Provided is a micro vibration damping system for a turning process capable of damping vibrations generated in a tool post by generating vibrations in an opposite direction to a vibration direction of the tool post during an instantaneous direction change, stop, or acceleration during the turning process for segmenting a machining chip in order to artificially control the tool post to vibrate in the opposite direction of the micro vibrations generated in the tool post such that the micro vibrations generated in the tool post are dampened.

According to an aspect of the present disclosure, a micro vibration damping system for a turning process, includes: one or more sensors configured to sense an instantaneous acceleration of a tool post during machining of a work piece; and a driver configured to drive the tool post in a direction orthogonal to an axial direction of the work piece according to the instantaneous acceleration of the tool post.

The one or more sensors may be configured to sense a speed signal of the tool post. The at least one processor may be further configured to obtain the speed signal of the tool post, a movement signal of the tool post, or an instantaneous speed change signal of the tool post; check one or more user input items corresponding to one or more machining conditions; obtain a machining movement distance of the tool post for machining the work piece and a fine movement distance of the tool post based on a rotation speed of the tool post during driving of the tool post and the one or more machining conditions of the work piece; control the driver to drive the tool post in the direction orthogonal to the axial direction of the work piece according to the machining movement distance and the fine movement distance; and control the driver to drive the tool post to continue machining of the work piece after the tool post is moved in the direction orthogonal to the axial direction of the work piece.

The at least one processor may be further configured to: wherein the at least one processor is further configured to control the driver to: drive the tool post in a vertical direction with respect to the axial direction of the work piece and a horizontal direction with respect to the axial direction of the work piece; and drive the tool post in the horizontal direction in a section of the work piece in which a rapid movement of the tool post occurs after the tool post stops, based on at least one of the speed signal of the tool post, the movement signal of the tool post, or the instantaneous speed change signal of the tool post.

The at least one processor may be further configured to control the driver to: drive the tool post to cut the work piece and instantaneously change a cutting speed of the tool post after the tool post stops cutting the work piece; and drive the tool post to the direction orthogonal, with respect to the axial direction of the work piece, in a vibration direction of the tool post when the cutting speed of the tool post is instantaneously changed.

The at least one processor may be further configured to control the driver to: implement vibrations in the horizontal direction by finely moving the tool post in the horizontal direction with respect to the axial direction of the work piece, which is orthogonal to a micro vibration direction of a micro vibration generated in the tool post, based on an instantaneous speed change due to instantaneous rapid acceleration of the tool post after the driving of the tool post is stopped; and return the tool post returns to an original location of the tool post as soon as the fine movement of the tool post is completed.

The at least one processor may be further configured to control the driver to damp vibrations of the tool post in the vertical direction, with respect to the axial direction of the work piece, by finely moving the tool post in the horizontal direction with respect to the axial direction of the work piece.

The one or more sensors may be further configured to sense a timing at which the tool post is finely moved in the vertical direction, with respect to the axial direction of the work piece, from the horizontal direction, based a time period in which the instantaneous acceleration of the tool post occurs after the tool post is stopped. The at least one processor is further configured to control the driver to drive the tool post in the horizontal direction during the time period in which the instantaneous acceleration of the tool post occurs after the tool post is stopped.

A distance by which the tool post is finely moved in the vertical direction may be automatically adjusted according to a speed of instantaneous movement of the tool post, an end of a set material, and a machining depth.

The micro vibration damping system may further include at least one controller. The at least one processor may be further configured to control the at least one controller to: control a speed of the driver for machining the work piece; and control a speed of the driver for the instantaneous acceleration of the tool post after the tool post for turning is stopped.

The at least one processor may be further configured to control the controller to receive an acceleration signal. The one or more sensors may be configured to sense a section of the tool post in which a rapid movement of the tool post occurs after the tool post stops.

The at least one processor may be further configured to control the at least one controller to: receive a vibration damping signal of the and control the tool post to stop the movement of the tool post in a vertical direction with respect to the work piece; and receive a movement stop signal of the tool post moving in the vertical direction with respect to the work piece from the one or more sensors and control the driver to decelerate the driver to a speed for machining.

According to another aspect of the present disclosure, a micro vibration damping method includes: sensing an instantaneous acceleration of a tool post during machining of a work piece; and driving the tool post in a direction orthogonal to an axial direction of the work piece according to the instantaneous acceleration of the tool post.

The micro vibration damping method may further include sensing a speed signal of the tool post; obtaining the speed signal of the tool post, a movement signal of the tool post, or an instantaneous speed change signal of the tool post; checking one or more user input items corresponding to one or more machining conditions; obtaining a machining movement distance of the tool post for machining the work piece and a fine movement distance of the tool post based on a rotation speed of the tool post during driving of the tool post and the one or more machining conditions of the work piece; driving the tool post in the direction orthogonal to the axial direction of the work piece according to the machining movement distance and the fine movement distance; and driving the tool post to continue machining of the work piece after the tool post is moved in the direction orthogonal to the axial direction of the work piece.

The micro vibration damping method may further include: sensing at least one of a speed signal of the tool post, a movement signal of the tool post, or an instantaneous speed change signal of the tool post; and controlling a movement of the tool post based at least one of the speed signal of the tool post, the movement signal of the tool post, or the instantaneous speed change signal of the tool post.

The controlling the movement of the tool post may include: moving the tool post in a vertical direction and a horizontal direction with respect to the axial direction of the work piece; and moving the tool post in the horizontal direction in a section of the work piece in which a rapid movement of the tool post occurs after the tool post stops, based on at least one of the speed signal of the tool post, the movement signal of the tool post, or the instantaneous speed change signal of the tool post.

The controlling the movement of the tool post further may include: cutting the work piece, via the tool post, and instantaneously changing a cutting speed of the tool post after the tool post stops cutting the work piece; and moving the tool post to the direction orthogonal, with respect to the axial direction of the work piece, in a vibration direction of the tool post when the cutting speed of the tool post is instantaneously changed.

The controlling the movement of the tool post may include: implementing vibrations in the horizontal direction by finely moving the tool post in the horizontal direction with respect to the axial direction of the work piece, which is orthogonal to a micro vibration direction of a micro vibration generated in the tool post, based on an instantaneous speed change due to instantaneous rapid acceleration of the tool post after the driving of the tool post is stopped; and moving the tool post to an original location of the tool post as soon as the fine movement of the tool post is completed.

The implementing vibrations in the horizontal direction may include damping vibrations of the tool post in the vertical direction by finely moving the tool post in the horizontal direction with respect to the axial direction of the work piece.

The controlling of the movement of the tool post may further include: sensing a timing at which the tool post is finely moved in the vertical direction, with respect to the axial direction of the work piece, from the horizontal direction, based a time period in which the instantaneous acceleration of the tool post occurs after the tool post is stopped; and controlling the movement of the tool post in the horizontal direction during the time period in which the instantaneous acceleration of the tool post occurs after the tool post is stopped.

The controlling of the movement of the tool post may include: calculating a distance by which the tool post is finely moved in the horizontal direction; and automatically adjusting the distance by which the tool post is finely moved in the horizontal direction according to a speed of instantaneous movement of the tool post, an end of a set material, and a machining depth.

The micro vibration damping system for a turning process and the method thereof one or more embodiments may implement small vibrations compared to an actual movement section by controlling an axis in a horizontal direction rather than a vertical direction based on a work piece, and may thus implement precise movement control compared to controlling the axis in the vertical direction based on the work piece.

### BRIEF DESCRIPTION OF DRAWINGS

The above and other aspects, features, and advantages of certain embodiments will be more apparent from the following description taken in conjunction with the accompanying drawings, in which:

FIG. 1 is a schematic driving block diagram of a micro vibration damping system for a turning process according to one or more embodiments of the present disclosure;

FIG. 2 is a schematic configuration block diagram of the micro vibration damping system for a turning process according to one or more embodiments of the present disclosure;

FIG. 3 is a schematic block diagram illustrating a configuration of the micro vibration damping system for a turning process according to one or more embodiments of the present disclosure and a driving state of the micro vibration damping system for a turning process according to the configuration;

FIG. 4 is a schematic view for comparing and describing movement of a tool post in a vertical direction and movement of the tool post in a horizontal direction for damping micro vibrations of the tool post in the micro vibration damping system for a turning process according to one or more embodiments of the present disclosure;

FIG. 5 is an enlarged view for comparing and describing the movement of the tool post in the vertical direction and the movement of the tool post in the horizontal direction for damping the micro vibrations of the tool post in the micro vibration damping system for a turning process according to one or more embodiments of the present disclosure;

FIG. 6 is a schematic view illustrating a drawing and an equation for calculating a fine movement distance in the micro vibration damping system for a turning process according to one or more embodiments of the present disclosure;

FIG. 7 is a flowchart for damping micro vibrations for a turning process according to one or more embodiments.

FIG. 8 is a driving flowchart for damping micro vibrations during machining and chip breaking of a work piece in a micro vibration damping method for a turning process according to one or more embodiments of the present disclosure; and

FIG. 9 is a schematic flowchart of movement of a tool post in the horizontal direction for damping vibrations of a tool post in the micro vibration damping method for a turning process according to one or more embodiments of the present disclosure.

### DETAILED DESCRIPTION

Advantages and features of embodiments (including methods) of the present disclosure will become apparent from the descriptions of non-limiting example embodiments provided below with reference to the accompanying drawings. However, the present disclosure is not limited to the example embodiments described herein, and may be implemented in various ways. The example embodiments are provided for making the present disclosure thorough and for fully conveying the scope of the present disclosure to those skilled in the art. Like reference numerals denote like elements throughout the descriptions.

Accordingly, in some embodiments, well-known process steps, well-known structures, and well-known techniques are not specifically described to avoid ambiguity in interpreting the present invention.

Terms used herein are for describing example embodiments rather than limiting the present disclosure. As used herein, the singular forms are intended to include plural forms as well, unless the context clearly indicates otherwise. Throughout this specification, the word “comprise” (or “include”) and variations such as “comprises” (or “includes”) or “comprising” (or “including”) will be understood to imply the inclusion of stated elements but not the exclusion of any other elements.

The terms “at least one of A, B and C”, “at least one of A, B, or C”, and “at least one of A, B and/or C” include each and every combination of A, B, and C. For example, “at least one of A, B, or C” may include only A, only B, only C, A and B, A and C, B and C, or all of A, B, and C.

In addition, the embodiments described in this specification will be explained with reference to the cross-sectional views and/or schematic diagrams, which are idealized illustrations of the present invention. Therefore, the shapes depicted in the exemplary drawings may vary due to manufacturing techniques and/or tolerances. Accordingly, the embodiments of the present invention are not limited to the specific forms shown but also include variations in shape resulting from the manufacturing process. Furthermore, in the drawings of the present invention, each component may be illustrated as being somewhat enlarged or reduced in size for convenience of explanation. Throughout the specification, the same reference numerals denote the same components.

Hereinafter, the present disclosure will be described with reference to the drawings for describing a micro vibration damping system for a turning process and a method thereof according to embodiments of the present disclosure.

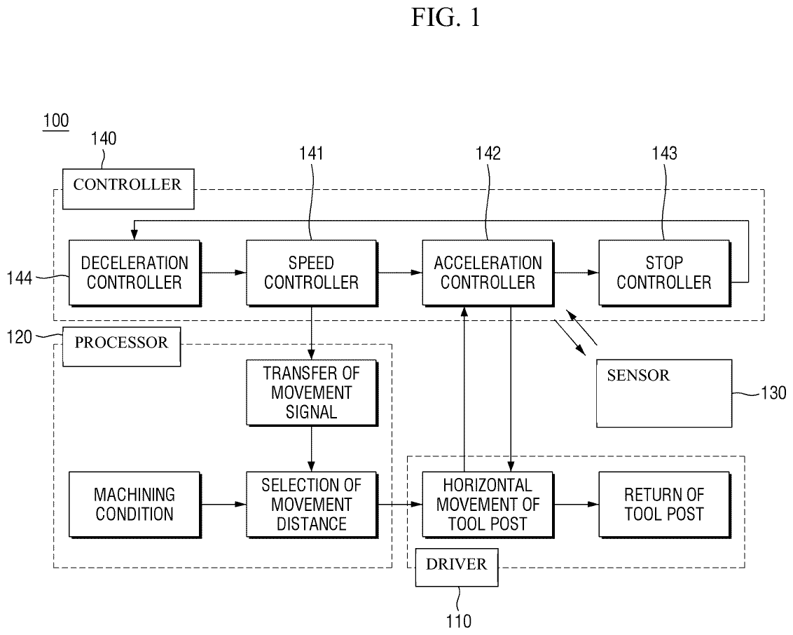

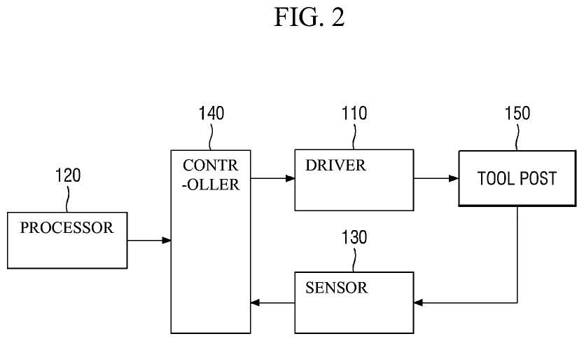

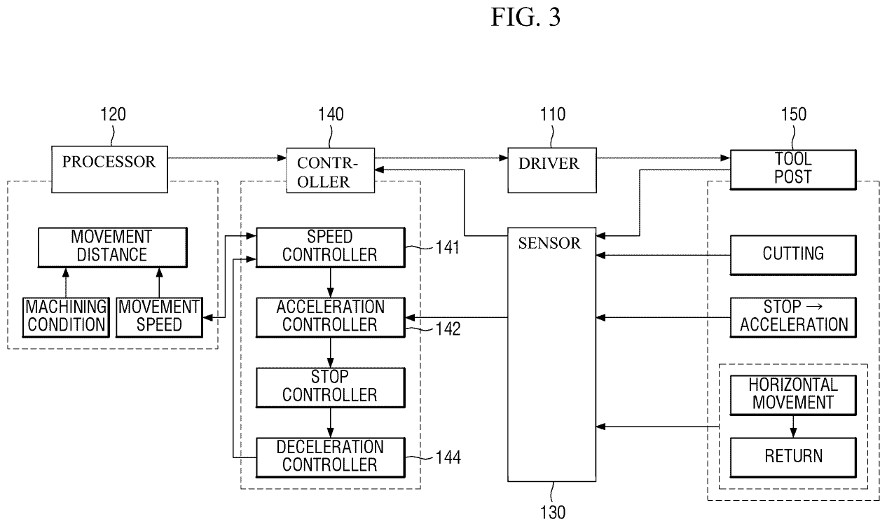

FIG. 1 is a schematic block diagram of a micro vibration damping system 100 for a turning process according to one or more embodiments of the present disclosure. FIG. 2 is a schematic configuration block diagram of the micro vibration damping system 100 for a turning process according to one or more embodiments of the present disclosure. FIG. 3 is a schematic block diagram illustrating a configuration of the micro vibration damping system 100 for a turning process according to one or more embodiments of the present disclosure and a driving state of the micro vibration damping system 100 for a turning process according to the configuration.

Referring to FIGS. 1 to 3, the micro vibration damping system 100 for a turning process and method thereof according to one or more embodiments of the present disclosure are provided to damp micro vibrations generated in a tool post 150 such as an automatic lathe due to an instantaneous direction change or stop and acceleration for a turning process for chip segmentation during an operation of a work piece on the tool post 150. The micro vibration damping system 100 for a turning process and the method thereof are used to damp micro vibrations generated in the tool post 150 with vibrations in an opposite direction that is artificially controlled, by applying a control algorithm that generates vibrations in the opposite direction to a vibration direction appearing in the tool post 150.

Specifically, referring to FIGS. 1 to 3, in the micro vibration damping system 100 for a turning process according to one or more embodiments of the present disclosure, for the purpose of chip segmentation or a turning process during machining of the work piece on the tool post 150, the tool post 150 is stopped and then instantaneously accelerated to be rapidly moved, such that a speed is changed. Vibrations are generated in the tool post 150 when the tool post 150 is instantaneously accelerated after being stopped. The micro vibration damping system 100 for a turning process according to one or more embodiments of the present disclosure may be provided to damp the vibrations generated in the tool post 150 by sensing the vibrations of the tool post 150 and controlling the fine movement and return of the tool post 150 in a direction horizontal to an axis of the work piece and a direction vertical to the vibration direction of the tool post 150.

Specifically, the micro vibration damping system 100 for a turning process according to one or more embodiments of the present disclosure may include the tool post 150, a driver 110, a processor 120, a sensor 130, and a controller 140.

The processor 120 may be at least one processor. The processor 120 may execute, for example, software (e.g., a program) to control at least one other component (e.g., a hardware or software component) of the micro vibration damping system 100 coupled with the processor 120, and may perform various data processing or computation. According to one embodiment, as at least part of the data processing or computation, the processor 120 may store a command or data received from another component in volatile memory, process the command or the data stored in the volatile memory, and store resulting data in non-volatile memory. According to one or more embodiments, the processor 120 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. For example, when the micro vibration damping system 100 includes the main processor and the auxiliary processor, the auxiliary processor may be adapted to consume less power than the main processor, or to be specific to a specified function. The auxiliary processor may be implemented as separate from, or as part of the main processor.

The auxiliary processor may control at least some of functions or states related to at least one component among the components of the micro vibration damping system 100, instead of the main processor while the main processor is in an inactive (e.g., sleep) state, or together with the main processor while the main processor is in an active state (e.g., executing an application). According to one or more embodiments, the auxiliary processor (e.g., an image signal processor or a communication processor) may be implemented as part of another component functionally related to the auxiliary processor. According to one or more embodiments, the auxiliary processor (e.g., the neural processing unit) may include a hardware structure specified for artificial intelligence model processing. An artificial intelligence model may be generated by machine learning. Such learning may be performed, e.g. the micro vibration damping system 100 where the artificial intelligence is performed or via a separate server. Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

A spindle may be described as an example of the tool post 150, and the tool post 150 may be provided to implement movement in a vertical direction and movement in a horizontal direction by the driver 110 to be described later.

The driver 110 may be provided to provide driving force to the tool post 150. The driver 110 may be provided to provide driving of the tool post 150 during rapid movement due to stop and instantaneous acceleration for segmentation of a chip generated during the machining of the work piece as well as driving of the tool post 150 for machining the work piece. As described later, the driver 110 may be provided to provide driving force for horizontal movement of the tool post 150 as well as vertical movement of the tool post 150.

The driver 110 may include one or more actuators and/or motors. The driver 110 may provide a driving force so that the tool post 150 moves in a direction different from an actual vibration direction of the tool post 150 in order to implement fine movement of the tool post 150 for damping the vibrations generated in the tool post 150. As described later, when the tool post 150 is stopped and instantaneously accelerated for the purpose of the chip segmentation, the actual vibration direction generated in the tool post 150 is a downward direction, i.e., the vertical direction, in which instantaneous vibrations are generated by weight of the tool post 150 and gravity. Accordingly, the fine movement of the tool post 150 may be implemented in the horizontal direction different from the vertical direction, which is the actual vibration direction of the tool post 150.

The driver 110 finely moves the tool post 150 in the horizontal direction in order to damp the vibration generated in the tool post 150, and provides driving force so as to return the tool post 150 to its original location as soon as the fine movement of the tool post 150 by a set distance is completed. Through the driving, in which the tool post 150 finely moves and returns as soon as the fine movement of the tool post 150 is completed, the tool post 150 may move in the opposite direction to the actually generated vibrations to damp the actually generated vibrations. In addition, the movement of the tool post 150 in the horizontal direction may be implemented in a section in which rapid movement of the tool post 150 after the stop of the tool post 150 occurs.

The processor 120 may calculate a fine movement distance of the tool post 150 according to a rotation speed according to the driving of the tool post 150 and a machining condition set according to the work piece.

For example, the processor 120 may receive a rotation speed or a movement speed of the tool post 150 through a speed controller 141 to be described later. In addition, user input items, specifically, machining conditions according to the work piece, may be input to the processor 120 by a user. The processor 120 may calculate a movement distance for the chip segmentation during machining of the work piece and the fine movement distance required to damp the vibrations of the tool post 150 when the tool post 150 is stopped and instantaneously accelerated for the purpose of the chip segmentation as well as a movement distance for machining the work piece according to the rotation speed or the movement speed of the tool post 150 and the machining condition.

The sensor 130 may be one or more sensors. The sensor 130 may be mounted on the tool post 150. The sensor 130 may be attached to the tool post 150, and may sense a speed signal of the tool post 150, a movement signal of the tool post 150, and/or an instantaneous speed change signal of the tool post 150. In particular, the sensor 130 sense an acceleration signal for a section in which stop and rapid movement of the work piece occur. The signal sensed by the sensor 130 may be applied to the controller 140 to be described later, specifically, an acceleration controller 142. The sensor 130 may include one or more accelerometers such as Piezoelectric Accelerometer, Micro-Electro-Mechanical Systems (MEMS) Accelerometers, Capacitive Accelerometers, Inertial Measurement Unit (IMU), not being limited thereto.

That is, the sensor 130 senses the section in which the rapid movement of the tool post 150 after the stop of the tool post 150 occurs for the purpose of the chip segmentation during machining. A sensing value of the sensor, which corresponds to the section in which the rapid movement of the tool post 150 after the stop of the tool post 150 occurs, 130 is applied to the controller 140 to be described below and controls the driving of the driver 110 so as to damp the vibrations generated due to an instantaneous speed change of the tool post 150 after the stop of the tool post 150. For example, in the present disclosure, the vibrations may be damped by implementing the movement of the tool post 150 in a direction different to the vibration direction of the tool post 150 in the section in which the rapid movement (instantaneous speed change) of the tool post 150 after the stop of the tool post 150 occurs. For example, the vibrations may be damped by implementing the movement of the tool post 150 in a direction horizontal to the vibration direction, which is a vertical direction, of the tool post 150 in the section in which the rapid movement (instantaneous speed change) of the tool post 150 after the stop of the tool post 150 occurs.

The controller 140, and each of controller within the controller 140, may be implemented by the at least one processor 120 and/or software modules stored in one or more memories to be executed by the at least one processor to perform one or more functions described herein. The controller 140 may be provided to receive the signal from the sensor 130 and control the driving of the driver 110 according to the movement distance calculated by the processor 120. For example, the controller 140 may control a driving speed of the driver 110 for cutting the work piece by the tool post 150 or control the driving of the driver 110 to damp the vibrations of the tool post 150 due to the instantaneous speed change of the tool post 150 for the chip segmentation that occurs during the machining of the work piece. In addition, the controller 140 may control the driving of the driver 110 so that a speed of the tool post 150 instantaneously accelerates in order to perform the machining of the work piece after performing the chip segmentation corresponds to a cutting speed.

When the controller 140 controls the speed of the tool post 150 for the chip segmentation, the controller 140 damps the micro vibrations generated in the tool post 150 by controlling the tool post 150 to move in a direction different from the vibration direction of the tool post 150 generated due to the instantaneous acceleration of the tool post 150 after the stop of the tool post 150, for example, the direction orthogonal (e.g. vertical) to the vibration direction of the tool post 150.

The controller 140 may include the speed controller 141, the acceleration controller 142, a stop controller 143, and a deceleration controller 144, each of which may be implemented by at least one processor and/or at least one software module stored in one or more internal or external memories to be executed by the at least one processor to perform one or more operations described herein. The at least one processor implementing each of these controllers 141-144 may be hardware similar to the processor 120 or may be included in the processor 120. Although the controller 140 is described as including four controllers 141-144 respectively performing the operations described herein. Two or more of these controllers 141-144 may be combined into one single controller which performs all operations of the combined two or more controllers. Also, at least part of operations of at least one of these controllers 141-144 may be performed by another of these controllers 141-144.

The speed controller 141 may control a speed of the driver 110 in order to machine the work piece. In addition, the speed controller 141 may set a movement speed, a machining speed, or/and a rotation speed according to the work piece or the tool post 150. A movement signal or/and movement signal data according to the rotation speed, the movement speed, or/and the machining speed of the tool post 150 set by the speed controller 141 may be applied to the processor 120. The movement signal or/and the movement signal data applied from the speed controller 141 to the processor 120 may be calculated by the processor 120 together with user input data (e.g., a machining condition) set according to the work piece or/and the tool post 150. The processor 120 receives the data and calculates a movement distance of the tool post 150 for machining the work piece and a movement distance of the tool post 150 for the chip segmentation.

The speed controller 141 may set a movement distance of the tool post 150 for the purpose of the chip segmentation, and may transfer an instantaneous acceleration signal of the driver 110 according to the rapid movement (instantaneous speed change) of the tool post 150 at a location for the chip segmentation to the acceleration controller 142 to be described below.

The acceleration controller 142 may be provided to receive an acceleration signal for the chip segmentation from the speed controller 141, receive an instantaneous speed detection value sensed by the sensor 130, and control a movement speed and/or a movement direction of the driver 110. When the instantaneous acceleration signal of the speed controller 141 and the sensor 130 is transferred to the acceleration controller 142, the tool post 150 performs the chip segmentation, but the vibrations are generated in an up-and-down direction vertical to an axial direction of the work piece provided in the horizontal direction. Accordingly, the acceleration controller 142 may be provided to control movement of the driver 110 in the horizontal direction and return movement of the driver 110 with respect to the axial direction in an instantaneous acceleration section of the tool post 150.

A movement distance of a horizontal axis of the tool post 150 may be variably and automatically adjusted according to a speed of the rapid movement of the tool post, a type of a set material, and a machining depth.

The stop controller 143 may be provided to receive a vibration signal of the tool post 150 sensed by the sensor 130 and a vibration damping signal of the driver 110 from the acceleration controller 142 and control the tool post 150 so that the movement of the recovered tool post 150 in the third direction is stopped.

The deceleration controller 144 may receive the third direction movement stop signal of the tool post 150 from the stop controller 143. The deceleration controller 143 may control the driver 110 so that the driver 110 is decelerated to a speed for machining so that machining of the work piece may be performed again when the tool post 150 returns to a location of the work piece.

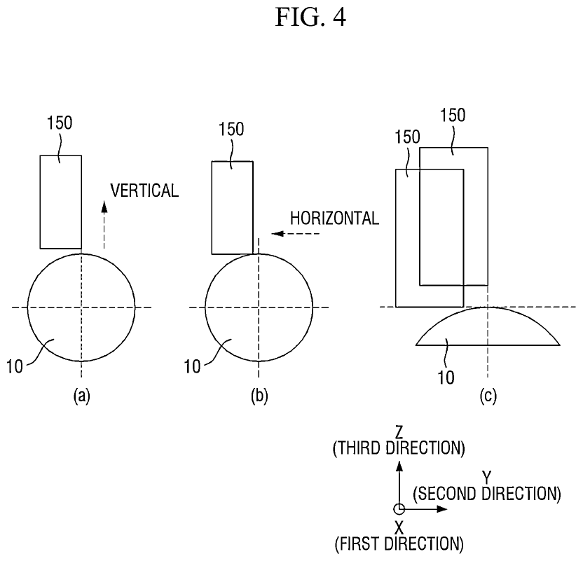

Hereinafter, fine movement of the tool post 150 will be described in more detail with reference to FIGS. 4 to 6.

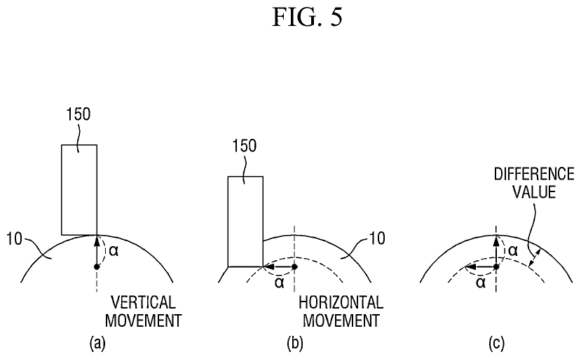

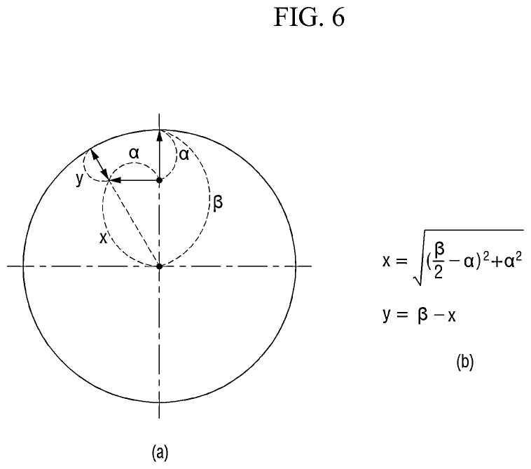

FIG. 4 is a schematic view for comparing and describing movement of a tool post in a vertical direction and movement of the tool post in a horizontal direction in the micro vibration damping system 100 for a turning process according to one or more embodiments of the present disclosure. FIG. 5 is an enlarged view for comparing and describing the movement of the tool post in the vertical direction and the movement of the tool post in the horizontal direction in the micro vibration damping system 100 for a turning process according to one or more embodiments of the present disclosure. FIG. 6 is a schematic view illustrating a drawing and an equation for calculating a fine movement distance in the micro vibration damping system 100 for a turning process according to one or more embodiments of the present disclosure.

Referring to FIGS. 4 to 6, the work piece 10 may have a first direction as an axis, for example, with an X-axis direction as an axis (herein referred to as a ‘axial direction’ and denoted in an X-axis direction). In this case, the tool post 150 may be driven in a second direction and a third direction, that is, a left and right direction (herein referred to as a ‘second direction’ or ‘horizontal direction’ and denoted in an Y-axis direction) and an up-and-down direction (herein referred to as a ‘third direction’ or ‘vertical direction’ and denoted in a Z-axis direction), vertical to the first direction of the work piece 10. The tool post 150 may be provided to be located on a surface of the work piece 10 and cut the work piece 10 that rotates while moving in the X-axis direction.

For the purpose of chip segmentation generated during machining of the work piece 10 or for the purpose of a turning process, the tool post 150 implements cutting after being stopped and then instantaneously accelerated. When the tool post 150 is stopped and then instantaneously rapidly accelerated for the purpose of the chip segmentation or the a turning process, force is applied to the tool post 150 in a downward direction due to gravity and weight of the tool post 150, such that instantaneous vibrations are generated in the up-and-down direction (the third direction or the Z-axis direction).

In order to prevent unbalance in roughness such as the occurrence of a band in the work piece 10 due to the vibrations of the tool post 150 in the up-and-down direction, the vibrations generated in the tool post 150 should be damped.

As illustrated in FIG. 4, the tool post 150 may be moved in the direction (the third direction, the up-and-down direction, or the Z-axis direction) vertical to the axial direction of the work piece 10 or moved in the direction (the second direction, the left and right direction, or the Y-axis direction) horizontal to the axial direction of the work piece 10.

However, it may be confirmed that when the axis is controlled in the vertical direction based on the work piece 10 machined by the tool post 150 to generate movement opposite to the vibrations, movement of the tool post 150 of a small size damping small vibrations of about 1 μm may not be generated. Accordingly, it may be seen that when the movement of the tool post 150 in the vertical direction and the movement of the tool post 150 in the horizontal direction are implemented at the same length, an influence of a movement distance of the tool post 150 on the work piece 10 having a circular shape is smaller when the tool post 150 is moved in the horizontal direction than when the tool post 150 is moved in the vertical direction. Accordingly, the tool post 150 is controlled to move around the axis of the work piece 10 in the direction horizontal to the left and right direction rather than the direction vertical to the up-and-down direction, such that a vibration effect smaller than an actual movement section is generated to implement more precise movement control than control in the vertical direction.

As described above, when the driver 110 implements the fine movement of the tool post 150 in order to damp the vibrations of the tool post 150 in the third direction (up-and-down direction), the driver 110 may be provided to finely move the tool post 150 in the second direction, that is, the horizontal direction, which is the left and right direction of the axis, orthogonal to the first direction, to damp the vibrations of the tool post 150 in the up-and-down direction.

Here, a timing at which the tool post 150 is finely moved in the second direction (the left and right direction or the Y-axis direction) is a during a period in which the occurrence of the movement due to instantaneous rapid acceleration of the tool post 150 after the tool post 150 is stopped is sensed through the sensor 130, and the movement of the tool post 150 in the direction second to the axial direction of the work piece 10 may be controlled during the period in which the movement occurs due to the instantaneous rapid acceleration of the tool post 150 after the stop of the tool post 150.

In addition, a distance by which the tool post 150 is finely moved in the second direction may be calculated by the processor 120. The distance by which the tool post 150 is finely moved in the second direction (the left and right direction or the Y-axis direction) may be automatically adjusted according to a speed of instantaneous movement of the tool post 150, an end of the set material, and a machining depth.

As illustrated in FIG. 5, it may be seen that when the movement of the tool post 150 in the vertical direction (see (a) of FIG. 5) and the movement of the tool post 150 in the horizontal direction (see (b) of FIG. 5) by a distance a of a cutting depth of the work piece 10 from a location of the tool post 150 for machining the work piece 10 are performed, a difference (see (c) of FIG. 5) in the location of the tool post 150 with respect to the work piece 10 is generated.

A location for a movement distance of the tool post 150 in the horizontal direction may be implemented through an equation disclosed in (b) of FIG. 6 using the distance a of the work piece 10 and a cutting depth R of the work piece 10, as illustrated in FIG. 6.

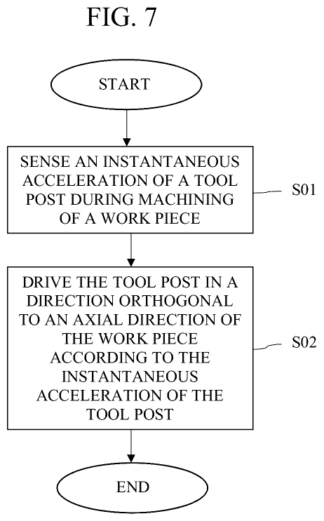

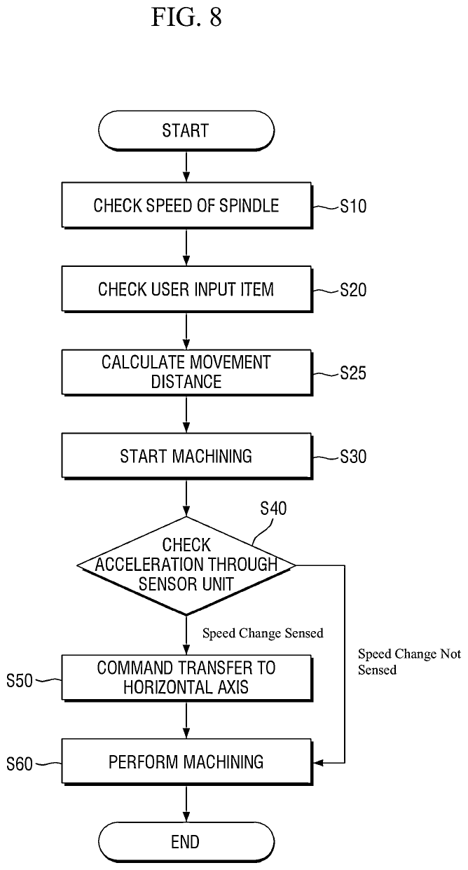

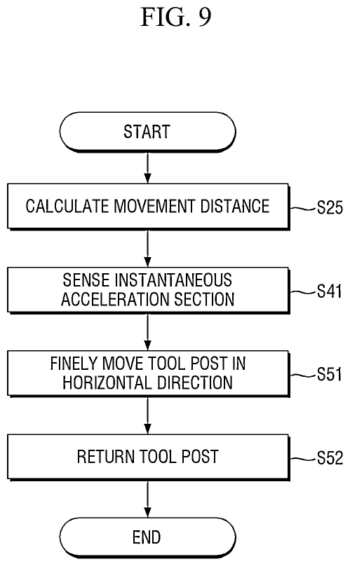

FIG. 7 is a machining flow chart for the micro vibration damping system for a turning process according to one or more embodiments. FIG. 8 is a machining flowchart of a work piece in a micro vibration damping method for a turning process according to one or more embodiments of the present disclosure. FIG. 9 is a schematic flowchart of the micro vibration damping method for a turning process according to one or more embodiments of the present disclosure.

First, referring to FIG. 7, a micro vibration damping method, according to one or more embodiments, may include sensing an instantaneous acceleration of a tool post during machining of a work piece (S01), and driving the tool post in a direction orthogonal to an axial direction of the work piece according to the instantaneous acceleration of the tool post (S02).

Referring to FIG. 8, a machining flow of a work piece according to one or more embodiments of the present disclosure may include a speed check step (S10) of the tool post 150 (spindle), a user input item (machining condition) check step (S20), a movement distance calculation step (S25) of the tool post 150, a machining start step (S30), an acceleration check step (S40) through the sensor 130, a horizontal movement step (S50), and a machining performing step (S60).

First, when the tool post 150 starts to machine the work piece, a rotation speed and a movement speed of the tool post 150 (e.g. spindle) are checked (speed check step (S10) of the tool post).

A user (operator) may input information for damping vibrations for a turning process such as a machining distance for chip segmentation or a turning process and a timing at which stop and rapid movement at the machining distance occurs, as well as a machining condition such as a type of work piece material and a machining depth of the work piece. The user may check such input items (user input item check step (S20)).

The processor 120 may calculate a movement distance of the tool post 150 in the horizontal direction during chip segmentation or a turning process of the tool post 150 as well as a location for the chip segmentation of the tool post 150 or a location for the turning process of the tool post 150 through the movement speed of the tool post 150 and the machining condition (movement distance calculation step (S25) of the tool post).

The controller 140 controls the driver 110 according to a set cutting depth, cutting length, chip segmentation location, or turning location of the work piece, and the tool post 150 starts to machine the work piece (machining start step (S30)).

The sensor 130 may sense a section in which stop and instantaneous rapid acceleration occur as well as the stop and the rapid movement due to the chip segmentation or the turning process of the tool post 150 (acceleration check step (S40) through the sensor).

When a speed change of the tool post 150 is not sensed by the sensor 130, the tool post 150 continuously performs the machining of the work piece (machining performing step (S60)).

On the other hand, when a signal of rapid movement due to the stop and the instantaneous acceleration of the tool post 150 is applied to the sensor 130, the signal of the sensor 130 may be applied to the controller 140, specifically, the acceleration controller 142. The controller 140, specifically, the acceleration controller 142, controls the movement of the driver 110 in the orthogonal (e.g. horizontal) direction through the value calculated by the processor 120 to allow the tool post 150 to perform fine movement in the orthogonal direction by a set distance. The tool post 150 moves by a set distance in a direction orthogonal to the left direction or the right direction based on the axis of the work piece (horizontal movement step (S50)).

Here, in the orthogonal (e.g. horizontal) movement step of the tool post, movement of the tool post in the left direction or the right direction by the set distance and a return of the tool post to its original location may be consecutively performed. The sensor 130 may apply a detection value according to the vibration damping and the return of the tool post 150 to the controller 140, specifically, the acceleration controller 142. In addition, the acceleration controller 142 may apply the value applied to the acceleration controller 142 to the stop controller 143, and the stop controller 143 may control the driving of the driver 110 to stop the movement of the tool post 150 in the horizontal direction. In addition, a control result for the return of the tool post 150 to its original location after the micro vibrations of the tool post 150 are damped by the driver 110 may be applied to the deceleration controller 144. The deceleration controller 144 may control the instantaneous acceleration of the tool post 150 through the applied control result and transfer a control result to the speed controller 141 so that the tool post 150 may be decelerated to and driven at a speed for machining the work piece.

As described above, after the tool post 150 is finely moved in the horizontal direction by the set distance, the tool post 150 is driven to immediately return to its original location. Thus, a vibration effect smaller than an actual movement section may be implemented, and a more precise movement control than control in the vertical direction may be implemented, and the vibrations generated in the tool post 150 may be artificially controlled and damped.

As described above, after the micro vibrations in the up-and-down direction generated in the tool post 150 during the chip segmentation or the turning process are damped, the tool post 150 returns to a machining location of the work piece, and accordingly, machines the work piece again (machining performing step (S60)).

As described above, the tool post 150 performs the machining of the work piece while implementing the chip segmentation or the turning process during cutting of the work piece. In this case, the micro vibration damping method for the turning process in the machining flow of the work piece will be specifically described with reference to FIG. 8.

Referring to FIG. 8, during the chip segmentation or the turning process, the tool post 150 is stopped and instantaneously accelerated, and the vibrations may be generated in the up-and-down direction in the tool post 150. Accordingly, the micro vibration damping method for the turning process may include a step (S25) of calculating a fine movement (movement) distance in order to damp the vibrations of the tool post 150 during the chip segmentation or the turning process, an instantaneous acceleration sensing step (S41) of sensing instantaneous rapid acceleration of the tool post 150 after stop of the tool post 150, a step (S51) of moving the tool post 150 in the horizontal direction according to a sensed result, and a return step (S52) of returning the tool post 150 after the micro vibrations are damped. As described above, in order to machine the work piece, the operator may input information related to the machining of the work piece, and the processor 120 may calculate the movement distance of the tool post 150 in the horizontal direction through the movement speed of the tool post and the machining condition (movement distance calculation step (S25) of the tool post). The movement distance of the tool post 150 in the horizontal direction calculated in the operation unit 120 may be variably adjusted according to the movement speed of the tool post 150 according to the instantaneous rapid acceleration of the tool post 150, the type of material, and the machining depth.

After the fine movement distance is calculated, the work piece may be machined (machining start step (S30)). In a machining state of the work piece, at the location for the turning process or the location for the chip segmentation, the tool post 150 may be stopped and instantaneously rapidly accelerated. When the tool post 150 is stopped and instantaneously rapidly accelerated, the vibrations in the up-and-down direction are generated in the tool post 150.

When the stop and the movement of the instantaneous rapid acceleration of the tool post 150 occur during the machining of the work piece by the tool post 150, the sensor 130 may be provided on the tool post 150 to sense the stop and the instantaneous rapid acceleration of the tool post 150 and also sense the vibrations (sensing step (S41)).

The sensing value sensed by the sensor 130 is applied to the acceleration controller 142. The acceleration controller 142 controls the driver 110 in another direction, specifically, the left and right direction horizontal to the axis of the work piece, that may damp the vibrations of the tool post 150 in the up-and-down direction in order to damp the vibrations of the tool post 150 in the up-and-down direction, such that the tool post 150 moves in the horizontal direction by a set fine movement distance (step (S51) of moving the tool post).

The tool post 150 is moved in either the left direction or the right direction horizontal to the axis of the work piece by the set fine movement distance and then immediately returns in an opposite direction (tool post return step (S52)).

As described above, as the tool post 150 actually vibrates in the up-and-down direction (direction vertical to the axis) based on the axis of the work piece, the tool post 150 is moved in a direction, that is, the direction horizontal to the axis, different from the up-and-down direction, and then immediately returns to its original location to damp the vibrations generated in the tool post 150. A timing for the movement of the tool post 150 in the horizontal direction may be applied in a section where the rapid movement of the tool post 150 after the stop of the tool post 150 occurs through the sensor 130 attached to the tool post.

While the present disclosure has been particularly shown and described with reference to exemplary embodiments thereof, it will be understood by those of ordinary skill in the art that the present disclosure is not limited to the same configurations and operations as the specific embodiments described above, and various changes in form and detail may be made therein without departing from the spirit and scope of the present disclosure as defined by the following claims. Therefore, the scope of the present disclosure is defined not by the detailed description of the invention but by the following claims, and all differences within the scope will be construed as being included in the present disclosure.

What is claimed is:

1. A micro vibration damping system comprising at least one processor configured to control:
one or more sensors configured to sense an instantaneous acceleration of a tool post during machining of a work piece; and
a driver configured to drive the tool post in a direction orthogonal to an axial direction of the work piece according to the instantaneous acceleration of the tool post.

2. The micro vibration damping system of claim 1, wherein the one or more sensors are configured to sense a speed signal of the tool post, and the at least one processor is further configured to:
obtain the speed signal of the tool post, a movement signal of the tool post, or an instantaneous speed change signal of the tool post;
check one or more user input items corresponding to one or more machining conditions;
obtain a machining movement distance of the tool post for machining the work piece and a fine movement distance of the tool post based on a rotation speed of the tool post during driving of the tool post and the one or more machining conditions of the work piece;
control the driver to drive the tool post in the direction orthogonal to the axial direction of the work piece according to the machining movement distance and the fine movement distance; and
control the driver to drive the tool post to continue machining of the work piece after the tool post is moved in the direction orthogonal to the axial direction of the work piece.

3. The micro vibration damping system of claim 2, wherein the at least one processor is further configured to control the driver to:
drive the tool post in a vertical direction with respect to the axial direction of the work piece and a horizontal direction with respect to the axial direction of the work piece; and
drive the tool post in the horizontal direction in a section of the work piece in which a rapid movement of the tool post occurs after the tool post stops, based on at least one of the speed signal of the tool post, the movement signal of the tool post, or the instantaneous speed change signal of the tool post.

4. The micro vibration damping system of claim 2, wherein the at least one processor is further configured to control the driver to:
drive the tool post to cut the work piece and instantaneously change a cutting speed of the tool post after the tool post stops cutting the work piece; and
drive the tool post to the direction orthogonal, with respect to the axial direction of the work piece, in a vibration direction of the tool post when the cutting speed of the tool post is instantaneously changed.

5. The micro vibration damping system of claim 3, wherein the at least one processor is further configured to control the driver to:
implement vibrations in the horizontal direction by finely moving the tool post in the horizontal direction with respect to the axial direction of the work piece, which is orthogonal to a micro vibration direction of a micro vibration generated in the tool post, based on an instantaneous speed change due to instantaneous rapid acceleration of the tool post after the driving of the tool post is stopped; and
return the tool post returns to an original location of the tool post as soon as the fine movement of the tool post is completed.

6. The micro vibration damping system of claim 5, wherein the at least one processor is further configured to control the driver to damp vibrations of the tool post in the vertical direction, with respect to the axial direction of the work piece, by finely moving the tool post in the horizontal direction with respect to the axial direction of the work piece.

7. The micro vibration damping system of claim 6, wherein the one or more sensors are further configured to sense a timing at which the tool post is finely moved in the vertical direction, with respect to the axial direction of the work piece, from the horizontal direction, based a time period in which the instantaneous acceleration of the tool post occurs after the tool post is stopped, and
wherein the at least one processor is further configured to control the driver to drive the tool post in the horizontal direction during the time period in which the instantaneous acceleration of the tool post occurs after the tool post is stopped.

8. The micro vibration damping system of claim 6, wherein a distance by which the tool post is finely moved in the vertical direction is automatically adjusted according to a speed of instantaneous movement of the tool post, an end of a set material, and a machining depth.

9. The micro vibration damping system of claim 2, further comprising at least one controller,
wherein the at least one processor is further configured to control the at least one controller to:
control a speed of the driver for machining the work piece; and
control a speed of the driver for the instantaneous acceleration of the tool post after the tool post for turning is stopped.

10. The micro vibration damping system of claim 9, wherein the at least one processor is further configured to control the at least one controller to receive an acceleration signal; and
the one or more sensors are configured to sense a section of the tool post in which a rapid movement of the tool post occurs after the tool post stops.

11. The micro vibration damping system of claim 9, wherein the at least one processor is further configured to control the at least one controller to:
receive a vibration damping signal of the driver and control the tool post to stop the movement of the tool post in a vertical direction with respect to the work piece; and
receive a movement stop signal of the tool post moving in the vertical direction with respect to the work piece from the one or more sensors and control the driver to decelerate the driver to a speed for machining.

12. A micro vibration damping method comprising:
sensing an instantaneous acceleration of a tool post during machining of a work piece; and
driving the tool post in a direction orthogonal to an axial direction of the work piece according to the instantaneous acceleration of the tool post.

13. The micro vibration damping method of claim 12, further comprising:
sensing a speed signal of the tool post,
obtaining the speed signal of the tool post, a movement signal of the tool post, or an instantaneous speed change signal of the tool post;
checking one or more user input items corresponding to one or more machining conditions;
obtaining a machining movement distance of the tool post for machining the work piece and a fine movement distance of the tool post based on a rotation speed of the tool post during driving of the tool post and the one or more machining conditions of the work piece;
driving the tool post in the direction orthogonal to the axial direction of the work piece according to the machining movement distance and the fine movement distance; and
driving the tool post to continue machining of the work piece after the tool post is moved in the direction orthogonal to the axial direction of the work piece.

14. The micro vibration damping method of claim 13, further comprising:
sensing at least one of the speed signal of the tool post, the movement signal of the tool post, or the instantaneous speed change signal of the tool post; and
controlling the movement of the tool post based at least one of the speed signal of the tool post, the movement signal of the tool post, or the instantaneous speed change signal of the tool post.

15. The micro vibration damping method of claim 14, wherein the controlling the movement of the tool post comprises:
moving the tool post in a vertical direction and a horizontal direction with respect to the axial direction of the work piece; and
moving the tool post in the horizontal direction in a section of the work piece in which a rapid movement of the tool post occurs after the tool post stops, based on at least one of the speed signal of the tool post, the movement signal of the tool post, or the instantaneous speed change signal of the tool post.

16. The micro vibration damping method of claim 15, wherein the controlling the movement of the tool post further comprises:
cutting the work piece, via the tool post, and instantaneously changing a cutting speed of the tool post after the tool post stops cutting the work piece; and
moving the tool post to the direction orthogonal, with respect to the axial direction of the work piece, in a vibration direction of the tool post when the cutting speed of the tool post is instantaneously changed.

17. The micro vibration damping method of claim 15, wherein the controlling the movement of the tool post comprises:
implementing vibrations in the horizontal direction by finely moving the tool post in the horizontal direction with respect to the axial direction of the work piece, which is orthogonal to a micro vibration direction of a micro vibration generated in the tool post, based on an instantaneous speed change due to instantaneous rapid acceleration of the tool post after the driving of the tool post is stopped; and
moving the tool post to an original location of the tool post as soon as the fine movement of the tool post is completed.

18. The micro vibration damping method of claim 17, wherein the implementing vibrations in the horizontal direction comprises damping vibrations of the tool post in the vertical direction by finely moving the tool post in the horizontal direction with respect to the axial direction of the work piece.

19. The micro vibration damping method of claim 17, wherein the controlling of the movement of the tool post further comprises:
sensing a timing at which the tool post is finely moved in the vertical direction, with respect to the axial direction of the work piece, from the horizontal direction, based a time period in which the instantaneous acceleration of the tool post occurs after the tool post is stopped; and
controlling the movement of the tool post in the horizontal direction during the time period in which the instantaneous acceleration of the tool post occurs after the tool post is stopped.

20. The micro vibration damping method of claim 17, wherein the controlling of the movement of the tool post comprises:
calculating a distance by which the tool post is finely moved in the horizontal direction; and
automatically adjusting the distance by which the tool post is finely moved in the horizontal direction according to a speed of instantaneous movement of the tool post, an end of a set material, and a machining depth.
